(19) United States
(12) Patent Application Publication
(10) Pub. No.: US 2020/0180755 A1
(43) Pub. Date: Jun. 11, 2020

(54) HYBRID HELICOPTER INCLUDING INCLINED PROPULSION PROPELLERS

(71) Applicant: AIRBUS HELICOPTERS, Marignane (FR)

(72) Inventor: Pierre PRUD'HOMME LACROIX, Vitrolles (FR)

(73) Assignee: AIRBUS HELICOPTERS, Marignane (FR)

(21) Appl. No.: 16/216,193

(22) Filed: Dec. 11, 2018

(51) Int. Cl. B64C 27/26; B64C 27/08; B64C 27/52; B64C 27/82

(52) U.S. Cl. CPC B64C 27/26; B64C 27/08; B64C 27/52; B64C 2027/8281; B64C 2027/8227; B64C 2027/8236; B64C 27/82

(57) ABSTRACT

The present invention relates to a hybrid helicopter comprising a fuselage, a main rotor, two wings situated on either side of said fuselage, and two propulsion propellers situated respectively on each wing. Each propulsion propeller is inclined, and when it rotates it generates a thrust force (F_{d}, F_{g}) along a thrust axis (P_{d}, P_{g}) that is inclined relative to a longitudinal direction (X) of said hybrid helicopter. As a result, a longitudinal component and a transverse component of said thrust force (F_{d}, F_{g}) of each propulsion propeller act, during hovering flight of said hybrid helicopter, to generate respective torques that combine to form a moment (Mₛₜₐₜ) opposing a yaw torque (C_{R}) of said hybrid helicopter.

### BACKGROUND OF THE INVENTION

### (1) Field of the Invention

The present invention relates to the field of hybrid helicopters, i.e. rotary wing aircraft fitted with auxiliary propulsion.

The present invention relates to a hybrid helicopter having propulsion propellers that are inclined relative to a longitudinal direction of the hybrid helicopter.

### (2) Description of Related Art

A rotary wing aircraft, also referred to as a “rotorcraft”, conventionally comprises a fuselage, at least one main rotor, and a power plant. Each main rotor is provided with a plurality of blades and is driven in rotation by the power plant, thereby providing the aircraft with lift and possibly also with propulsion. By way of example, the power plant may comprise a turboshaft engine with a main gearbox (MGB) arranged between each turboshaft engine and the main rotor.

A rotary wing aircraft is also traditionally provided with an anti-torque device that performs an anti-torque function so as to oppose a yaw torque of the aircraft. This yaw torque is made up mainly of rotor torque generated by rotation of the main rotor, and also, to a smaller extent, by torques due to secondary phenomena, e.g. constituted by the actions of the air stream generated by the rotation of the main rotor on the fuselage of the aircraft, on the tail boom, and on stabilizers, if any. These secondary phenomena may also be caused by the wind to which the aircraft might be subjected or by the movements of the aircraft. As a result, this yaw torque tends to cause the fuselage of the aircraft to turn about an instantaneous axis of rotation passing through the center of rotation of the main rotor or close to that center of rotation, and in the direction opposite to the direction of rotation of the main rotor. This instantaneous axis of rotation is generally close to the yaw axis of the aircraft, and may indeed substantially coincide therewith.

By way of example, an anti-torque device is constituted by an auxiliary rotor arranged at the rear end of the tail boom of the aircraft and commonly referred by the person skilled in the art as the “rear rotor”, or the “anti-torque rotor”, or indeed the “tail rotor”.

It should be recalled that an (X, Y, Z) reference frame is generally associated with the aircraft, being formed by a longitudinal direction X extending from the front towards the rear of the aircraft, an elevation direction Z extending upwards perpendicularly to the longitudinal direction X, and a transverse direction Y extending from the left to the right of the aircraft, perpendicularly to the longitudinal and elevation directions X and Z. The longitudinal direction X is parallel to the roll axis of the aircraft, the transverse direction Y is parallel to its pitching axis, and the elevation direction Z is parallel to its yaw axis.

Under such conditions, a hybrid helicopter is a rotary wing aircraft including at least one main rotor, a fuselage, and a power plant, together with auxiliary propulsion. A hybrid helicopter may also include a lift surface, generally made up of two wings situated on either side of the fuselage, together with one or more substantially horizontal and/or vertical stabilizers positioned at one end of the aircraft, typically on a tail boom of the aircraft. The auxiliary propulsion may be formed by one or more propulsion propellers, e.g. two propulsion propellers situated on either side of the fuselage.

Numerous embodiments of hybrid helicopters including auxiliary propulsion are known in the prior art.

For example, document WO 2009/108178 describes a rotorcraft having a fuselage, two main rotors that are coaxial and contrarotating, together with two ducted propellers arranged at the rear of the fuselage on either side of a longitudinal mid-line. Each propeller provides horizontal thrust enabling the rotorcraft to reach high speeds of advance. The two propellers may be directed parallel to a longitudinal direction of the aircraft, or they may be inclined relative to that longitudinal direction so that their thrust axes are no longer parallel.

Document US 2009/0014580 describes a rotorcraft having a fuselage, at least one main rotor, and two ducted propellers arranged on either side of the fuselage. The two propellers are tiltable about a transverse axis and they are provided with respective movable vanes enabling the stream of air that has passed through the propeller to be directed. In the vertical position, each propeller generates vertical thrust that is additional to the lift generated by each main rotor for hovering flight and for flight at a low speed of advance. The movable vane then serves to provide the rotor with yaw control. In the horizontal position, each propeller generates horizontal thrust that is added to the forward aerodynamic force generated by each main rotor for cruising flight at high speeds of advance. The movable vane then serves to provide the rotorcraft with roll control.

Also known is Document FR 2 983 171, which describes a rotorcraft having a fuselage, a main rotor, and two propellers arranged at the rear of the fuselage, on either side of a longitudinal mid-line. The two propellers are inclined so that their thrust axes converge towards the front of the aircraft. As a result, those two propellers can also provide the rotorcraft with longitudinal thrust while simultaneously conserving transverse thrust for the anti-torque function, with those two thrusts being controllable independently of each other.

Document JP 2009/051465 describes a rotorcraft having two propellers arranged on the tail boom of the rotorcraft. The two propellers are ducted and inclined in such a manner that their thrust axes converge towards the longitudinal axis of the tail boom behind the two propellers, i.e. between the rear end of the tail boom and those two propellers.

Finally, Document EP 2 407 377 is known, which describes a rotorcraft having a steerable tail rotor that can be moved reversibly from operating in an anti-torque mode to operating in a propulsive mode.

For a hybrid helicopter, the auxiliary propulsion has the main function of generating a longitudinal thrust force enabling the aircraft to achieve high speeds of advance in cruising flight. Where appropriate, each lift surface of the hybrid helicopter contributes to providing it with lift. As a result, a hybrid helicopter can travel long distances at high speeds of advance in cruising flight.

When this auxiliary propulsion is provided by two propulsion propellers situated on either side of the fuselage of the hybrid helicopter, it also serves, while the two propulsion propellers are delivering differential thrusts, to generate a moment about a substantially vertical instantaneous axis of rotation of the aircraft passing through its center of gravity or close thereto, and also close to or coinciding with its yaw axis. This moment generated by the propulsion propellers thus opposes the yaw torque of the hybrid helicopter. This moment can also generate movement of the hybrid helicopter about its yaw axis.

The value of this moment is a function firstly of the thrust forces from the propulsion propellers, and in particular from their difference, and secondly from the spacing in the transverse direction Y between the respective thrust axes of the propulsion propellers and the yaw axis, the thrust axis of each propeller generally being parallel to the longitudinal direction X of the aircraft. Since the yaw axis is close to the center of rotation of the main rotor, and may indeed pass through this center of rotation, this spacing in the transverse direction Y between the thrust axis of each propulsion propeller can be considered relative to the position of the center of rotation of the main rotor, and it corresponds to the lever arm in the transverse direction Y corresponding to the thrust force of each propulsion propeller and thereby defining this moment.

Furthermore, this moment generated by the propulsion propellers is necessary mainly during hovering flight and flight at low speeds of advance in order to balance the yaw torque of the hybrid helicopter, since the torque generated by the rotation of the main rotor is at a maximum during such stages of flight. Specifically, during cruising flight at high speeds of advance, the rotor torque is smaller than during hovering flight or flight at low speeds of advance, with the main rotor of a hybrid helicopter generally having its speed of rotation reduced during cruising flight. Furthermore, a hybrid helicopter generally includes one or more substantially vertical stabilizers that act during cruising flight to generate a transverse aerodynamic force that opposes the yaw torque of the hybrid helicopter in part, or even in full.

Under such circumstances, a single parameter associated with the geometrical shape of the aircraft, specifically the transverse spacing of each propulsion propeller from the position of the center of rotation of the main rotor, has an influence on this moment that is generated by the propulsion propellers and that serves to balance the yaw torque of the hybrid helicopter during hovering flight and flight at low speeds of advance. Furthermore, a hybrid helicopter also has size constraints that put a limit in particular on those transverse dimensions and therefore on the positioning of the propulsion propellers, and consequently puts a limit on their lever arms in the transverse direction Y. Consequently, the potential for having an influence on this moment is limited and may make it necessary to increase the power consumed by the propulsion propellers in order to compensate for a lever arm that is limited in the transverse direction Y. Such an increase in the power consumed by the propulsion propellers is associated unfavorably with an increase in the power delivered by the power plant, and consequently with an increase in its weight to the detriment of the payload that can be transported by the hybrid helicopter and/or to the detriment of its range.

### BRIEF SUMMARY OF THE INVENTION

An object of the present invention is thus to propose a hybrid helicopter that makes it possible to avoid the above-mentioned limitations and increase the value of the moment generated by the propulsion propellers of a hybrid helicopter during hovering flight and flight at low speeds of advance while balancing the yaw torque of the hybrid helicopter, and to do so independently of the power consumed by each propulsion propeller. The present invention thus makes it possible to limit the weight of the power plant of a hybrid helicopter so as to improve the payload it can transport and/or its range. The present invention also makes it possible to increase the number of geometrical shape parameters associated with a hybrid helicopter, and in particular with the positioning of its propulsion propellers, that have an influence on the value of the moment generated by the propulsion propellers.

According to the invention, a hybrid helicopter is defined in a (X, Y, Z) right-handed rectangular reference frame, comprising a longitudinal direction X extending from the front of the hybrid helicopter towards the rear of the hybrid helicopter, an elevation direction Z extending upwards perpendicularly to the longitudinal direction X, and a transverse direction Y extending from the left towards the right of the hybrid helicopter, perpendicularly to the longitudinal and elevation directions X and Z.

Under such circumstances, the term “longitudinal” relates to any direction parallel to the longitudinal direction X, the term “transverse” relates to any direction parallel to the transverse direction Y, and the terms “elevation” and “vertical” relate to any direction parallel to the elevation direction Z.

A front-to-rear plane XZ of the hybrid helicopter can also be defined perpendicularly to the transverse direction Y. This front-to-rear plane XZ extends from a front end of the hybrid helicopter towards a rear end of the hybrid helicopter, parallel to the elevation direction Z. This front-to-rear plane XZ is thus formed by the longitudinal direction X and the elevation direction Z as defined above. In principle, this front-to-rear plane XZ is vertical when the hybrid helicopter is on the ground. A horizontal plane XY can also be defined perpendicularly to the elevation direction Z, the horizontal plane XY being formed by the longitudinal direction X and the transverse direction Y.

In the invention, a hybrid helicopter comprises:

a fuselage;

a main rotor rotatable about a center of rotation A;

at least two propulsion propellers situated transversely on either side of the front-to-rear plane XZ of the hybrid helicopter, each propulsion propeller having a respective thrust axis P_{d}, P_{g} along which a thrust force F_{d}, F_{g} is generated during rotation of the propulsion propeller; and

a power plant driving the main rotor and each propulsion propeller in rotation.

The longitudinal direction X is parallel to the roll axis of the hybrid helicopter, the transverse direction Y is parallel to its pitching axis, and the elevation direction Z is parallel to its yaw axis.

Furthermore, the center of rotation A of the main rotor is close to the yaw axis of the hybrid helicopter, without necessarily being situated on the yaw axis. The center of rotation A of the main rotor and the yaw axis are generally situated in the front-to-rear plane XZ of the hybrid helicopter.

The hybrid helicopter of the invention preferably includes only one main rotor. The main rotor has a plurality of main blades and it constitutes a rotary wing when it rotates. The main rotor thus provides the hybrid helicopter with lift, and possibly also with propulsion. The hybrid helicopter of the invention may also include a lift surface formed by at least two wings situated on either side of the fuselage of the hybrid helicopter. The lift surface is suitable for contributing to providing the hybrid helicopter with lift, mainly during cruising flight at high speeds of advance.

The hybrid helicopter of the invention may also have one or more substantially horizontal and/or substantially vertical stabilizers positioned at one end of the aircraft, e.g. on a tail boom. The stabilizers contribute in particular to stabilizing the hybrid helicopter aerodynamically. During cruising flight, each vertical stabilizer also serves to generate a transverse aerodynamic force that contributes in part, or even in full, to the anti-torque function, thereby opposing the yaw torque of the hybrid helicopter and/or capable of causing the hybrid helicopter to turn about its yaw axis.

Each propulsion propeller has a plurality of secondary blades that, when they rotate, generates a thrust force F_{d}, F_{g}, thereby constituting auxiliary propulsion for the hybrid helicopter serving to propel the hybrid helicopter. Furthermore, by providing different thrust forces F_{d}, F_{g}, the propulsion propellers serve to generate a moment in order to contribute to the anti-torque function opposing the yaw torque of the hybrid helicopter and/or in order to generate movement of the hybrid helicopter about its yaw axis.

When the hybrid helicopter of the invention has wings situated on either side of the fuselage so as to constitute a lift surface, at least one propulsion propeller may be situated on one of the wings.

The main rotor and each propulsion propeller are driven in rotation by a power plant, the main rotor generally having a speed of rotation that is different from that of the propulsion propellers. The power plant comprises one or more engines, e.g. one or more turboshaft engines, a main gearbox (MGB), and auxiliary gearboxes. The main gearbox connects each motor to the main rotor in order to drive it in rotation, and each auxiliary gearbox connects the main gearbox to a respective propulsion propeller in order, likewise, to drive it in rotation.

The hybrid helicopter of the invention is remarkable in that the thrust axis P_{d}, P_{g} of each propulsion propeller is inclined relative to the longitudinal direction X, with the thrust force F_{d}, F_{g} generated by each propulsion propeller while rotating comprising a longitudinal component and a transverse component, and in that each propulsion propeller is offset longitudinally relative to the center of rotation A of the main rotor in such a manner that the longitudinal component and the transverse component of the thrust force F_{d}, F_{g} of each propulsion propeller act during hovering flight or flight at a low speed of advance of the hybrid helicopter to generate a respective moment that balances the yaw torque of the hybrid helicopter.

In the prior art, the thrust axis of each propulsion propeller of a hybrid helicopter is generally arranged parallel to the longitudinal direction X of the hybrid helicopter so that the thrust force of a propulsion propeller is used in full for generating advance of the hybrid helicopter during cruising flight.

Those propulsion propellers can also act, e.g. during hovering flight, to generate a moment Mₛₜₐₜ opposing the yaw torque of the hybrid helicopter by supplying different thrust forces. The contribution of each propulsion propeller to the moment Mₛₜₐₜ is the product of the thrust force of that propulsion propeller multiplied by the transverse lever arm.

Advantageously, the thrust axis P_{d}, P_{g} of each propulsion propeller of the hybrid helicopter of the invention is inclined relative to the longitudinal direction X, the thrust axis P_{d}, P_{g} of a propulsion propeller forming an angle θ_{d}, θ_{g} with the longitudinal direction X in a plane parallel to the horizontal plane XY. Each angle θ_{d}, θ_{g} is thus defined about a vertical direction parallel to the elevation direction Z. This angle θ_{d}, θ_{g} between the longitudinal direction X and the thrust axis P_{d}, P_{g} of a propulsion propeller characterizes the inclination of each thrust axis P_{d}, P_{g}. This angle θ_{d}, θ_{g} is preferably identical for each of the propulsion propellers.

Under such circumstances, with the propulsion propellers positioned transversely on either side of the front-to-rear plane XZ, and thus on either side of the center of rotation A and of the yaw axis of the hybrid helicopter, with a certain amount of transverse offset, the longitudinal component of the thrust force F_{d}, F_{g} of each propulsion propeller causes torque to appear about an instantaneous axis of rotation passing through the center of rotation A of the main rotor of the hybrid helicopter or close to that center of rotation, with a lever arm that is equal to the transverse offset.

Likewise, since the propulsion propellers are positioned longitudinally either in front of or behind the center of rotation A of the main rotor, and thus in front of or behind the yaw axis of the hybrid helicopter, which is close to the center of rotation A, with a certain amount of longitudinal offset, the transverse component of the thrust force F_{d}, F_{g} of each propulsion propeller causes a torque to appear about the instantaneous axis of rotation of the hybrid helicopter with a lever arm that is equal to the longitudinal offset.

This instantaneous axis of rotation of the hybrid helicopter is generally close to or substantially coincides with the yaw axis and it is close to the center of rotation A of the main rotor, so that the lever arm of each thrust force F_{d}, F_{g} contributing to generating this moment Mₛₜₐₜ can be defined relative to the center of rotation A. Specifically, the center of rotation A is a mechanical center such that the distance between the center of rotation A and the position of each propulsion propeller can be determined accurately. In contrast, the instantaneous axis of rotation of the hybrid helicopter and the yaw axis are theoretical axes, having positions that can vary while the helicopter is in flight. Their positions are thus more difficult to define in reliable and accurate manner. Advantageously, the differences between these axes and the center of rotation A remain small, such that using the position of the center of rotation A for determining each lever arm constitutes a reliable approximation.

Consequently, the longitudinal component and the transverse component of the thrust force F_{d}, F_{g} generated by each rotating propulsion propeller act simultaneously, with each of them generating a torque.

During cruising flight, the thrust forces F_{d}, F_{g} of the propulsion propellers are directed towards the front of the hybrid helicopter and they are of substantially the same magnitude. As a result, the torques generated by the thrust forces F_{d}, F_{g} of these propulsion propellers balance, and therefore produce little effect on the hybrid helicopter.

Advantageously, when hovering or flying at low speed of advance, for which the yaw torque of the hybrid helicopter is large and due essentially to the rotor torque generated by rotation of the main rotor, the thrust forces F_{d}, F_{g} of the propulsion propellers positioned transversely on either side of the front-to-rear plane XZ exert different thrust forces F_{d}, F_{g}. Under such circumstances, the torques generated by the thrust forces F_{d}, F_{g} of the propulsion propellers combine and indeed add, to form a moment Mₛₜₐₜ that balances the yaw torque of the hybrid helicopter, i.e. mainly the rotor torque generated by rotation of the main rotor together with, to a small extent, torques generated by secondary phenomena, e.g. constituted by the action of the air stream generated by the rotation of the main rotor on the fuselage, on the tail boom, and on the stabilizers, if any, of the hybrid helicopter, by the wind to which the hybrid helicopter is subjected, or indeed by movements of the hybrid helicopter.

In particular, the thrust forces F_{d}, F_{g} generated by the propulsion propellers situated transversely on either side of the front-to-rear plane XZ may be directed in substantially opposite directions so as to generate a maximum moment Mₛₜₐₜ. The direction of the thrust force F_{d}, F_{g} of each propulsion propeller on either side of the front-to-rear plane XZ is then defined as a function of the direction of the yaw torque of the hybrid helicopter, and therefore as a function of the direction of rotation of the main rotor.

Advantageously, the inclination of the thrust axes P_{d}, P_{g} of the propulsion propellers serves to increase the moment Mₛₜₐₜ generated by the thrust forces F_{d}, F_{g} of the propulsion propellers of the hybrid helicopter of the invention compared with propulsion propellers that are arranged parallel to the longitudinal direction X, for identical power consumption.

For example, for a hybrid helicopter of the invention having two propulsion propellers respectively on the right and on the left and situated on either side of the front-to-rear plane XZ of the hybrid helicopter and offset longitudinally relative to the center of rotation A of the main rotor, the moment Mₛₜₐₜ generated by the thrust forces F_{d}, F_{g} from the two propulsion propellers can be determined in reliable and accurate manner when a first thrust force F_{d}, F_{g} is directed towards the front of the hybrid helicopter, and thus of a magnitude that is considered to be negative, and a second thrust force F_{d}, F_{g} is directed towards the rear of the hybrid helicopter, and is thus considered to be positive, e.g. during hovering flight, by the following equation:

Mₛₜₐₜ=F_{d}((y_{d}−y_{Rot})cos(θ_{d})−(x_{d}-x_{Rot})sin(θ_{d})) +F_{g}((y_{g}-y_{Rot})cos(θ_{g})−(x_{g}-x_{Rot})sin(θ_{g})).

F_{d}, F_{g} being the magnitude of the thrust force F_{d}, F_{g} generated respectively by rotation of the right and left propulsion propellers;

x_{d}, x_{g} being the longitudinal coordinate of the left and right propulsion propellers respectively in the (X, Y, Z) reference frame;

y_{d}, y_{g} being the transverse coordinate of the right and left propulsion propellers respectively in the (X, Y, Z) reference frame;

x_{Rot} being the longitudinal coordinate of the center of rotation A of the main rotor in the (X, Y, Z) reference frame;

y_{Rot} being the transverse coordinate of the center of rotation A of the main rotor in the (X, Y, Z) reference frame; and

θ_{d}, θ_{g} being the angle between the longitudinal direction X and the respective thrust axes P_{d}, P_{g} of the right and left propulsion propellers, respectively, this angle θ_{d}, θ_{g} being considered to be positive in the counterclockwise direction.

It can be seen that this increase in the moment Mₛₜₐₜ compared with the prior art is associated with the inclination of the first axis P_{d}, P_{g} of each propulsion propeller as characterized by the angle θ_{d}, θ_{g}, in combination with the longitudinal lever arm in the longitudinal direction X associated with the thrust force F_{d}, F_{g} of each propulsion propeller, the longitudinal lever arm being equal to the difference between the longitudinal positions of the propulsion propellers and of the center of rotation A of the main rotor.

This increase in the moment Mₛₜₐₜ is obtained with a small reduction in the traction force F_{tract} supplied jointly by the propulsion propellers of the hybrid helicopter during advance of the hybrid helicopter, since only the longitudinal components of the thrust forces F_{d}, F_{g} of the propulsion propellers contribute to this traction force. Specifically, the transverse components are opposite and cancel during cruising flight. This traction force F_{tract} is then defined by the following equation:

F_{tract}=F_{d}cos(θ_{d})+F_{g}cos(θ_{g})

Consequently, the inclination of the thrust axis P_{d}, P_{g} of each propulsion propeller of the hybrid helicopter of the invention amounts advantageously to artificially increasing the effective lever arm of each thrust force F_{d}, F_{g} that contributes to delivering the moment Mₛₜₐₜ during hovering flight, for example, at the cost of a small loss of efficiency for each propulsion propeller in cruising flight.

Increasing the angle θO_{d}, θ_{g} between the longitudinal direction X and the thrust axis P_{d}, P_{g} of a propulsion propeller leads to an increase in this moment Mₛₜₐₜ in hovering flight and in flight at a low speed of advance, and also to a reduction in the traction force F_{tract} that is delivered jointly by the propulsion propellers in cruising flight. Under such circumstances, the angle θ_{d}, θ_{g} is defined so as to obtain a compromise between the increase in the moment Mₛₜₐₜ and the supply of sufficient traction force F_{tract} to perform cruising flight. The angle θ_{d}, θ_{g} is preferably small so as to avoid significantly degrading this traction force F_{tract} in cruising flight, while providing an increase for the moment Mₛₜₐₜ in hovering flight. Depending on the geometrical shape of the aircraft, this angle θ_{d}, θ_{g} lies in the range 0° and a maximum angle θₘₐₓ that is defined as a function of the position of a propulsion propeller relative to the center of rotation A of the main rotor, such that:

$${θ}_{max} = atan ( \frac{x - {x}_{Rot}}{y - {y}_{Rot}} )$$

For example, this maximum angle θₘₐₓ may be equal to 10°.

It may be observed that for an angle θ_{d}, θ_{g} lying in the range 3° to 5°, the increase in the moment Mₛₜₐₜ is of the order of 1% in hovering flight, with a reduction in the traction force F_{tract} that is of the order of 0.25% in cruising flight.

The longitudinal and transverse lever arms associated with the thrust force F_{d}, F_{g} of each propulsion propeller have no direct effect on the traction force F_{tract}, but they do serve to modify the value of the moment Mₛₜₐₜ. Nevertheless, these lever arms are associated directly with how the propulsion propellers are installed on the hybrid helicopter and on how the mechanical transmissions are installed that are needed for driving each propulsion propeller in rotation.

Under such circumstances, the longitudinal and transverse positions x_{d}, x_{g} and y_{d}, y_{g} of each propulsion propeller may be defined so as to obtain good positioning for the center of gravity and good flying behavior for the hybrid helicopter as a result of the propulsion propellers being inclined, while also optimizing the moment Mₛₜₐₜ that balances the yaw torque of the hybrid helicopter during hovering flight.

Furthermore, the longitudinal position x_{d}, x_{g} of each propulsion propeller relative to the center of rotation A of the main rotor also has an influence on the direction in which the first axes P_{d}, P_{g} of the propulsion propellers are inclined. Specifically, depending on whether a propulsion propeller is located in front of or else behind the center of rotation A of the main rotor in the longitudinal direction X, the inclinations of the thrust axes P_{d}, P_{g} of the propulsion propellers need to be adapted so that the longitudinal and transverse components of each thrust force F_{d}, F_{g} both contribute to generating a moment Mₛₜₐₜ for balancing the yaw torque of the hybrid helicopter.

In a first embodiment, the propulsion propellers are arranged behind the center of rotation A of the main rotor in the longitudinal direction X, and the thrust axes P_{d}, P_{g} of the propulsion propellers then converge on each other towards the rear of the hybrid helicopter.

In a second embodiment, the propulsion propellers are arranged in front of the center of rotation A of the main rotor in the longitudinal direction X, and the thrust axes P_{d}, P_{g} of the propulsion propellers then converge on each other towards the front of the hybrid helicopter.

Advantageously, the inclinations of the thrust axes P_{d}, P_{g} of the propulsion propellers of the hybrid helicopter of the invention and the longitudinal and transverse offsets of the positions of the propulsion propellers relative to the position of the center of rotation A of the main rotor of the hybrid helicopter thus serve to optimize the efficiency of the propulsion propellers between hovering flight and advancing flight, without modifying the power available within the hybrid helicopter.

Consequently, since the power of the power plant of a rotary wing aircraft is generally determined to satisfy its power requirements during hovering flight, which is the stage of flight that requires the most power, the hybrid helicopter of the invention serves advantageously to reduce the power required of the power plant, and consequently to improve the performance in hovering flight, e.g. to improve its maximum weight. The performance of the hybrid helicopter of the invention may be degraded a little but only in cruising flight, where cruising flight generally requires less power than hovering flight or flight at a low speed of advance.

### BRIEF DESCRIPTION OF THE DRAWINGS

The invention and its advantages appear in greater detail from the following description of embodiments given by way of illustration and with reference to the accompanying figures, in which:

FIG. 1 is a view of a hybrid helicopter;

FIGS. 2 and 3 are two plan views of a prior art hybrid helicopter; and

FIGS. 4 to 7 are plan views of a hybrid helicopter of the invention.

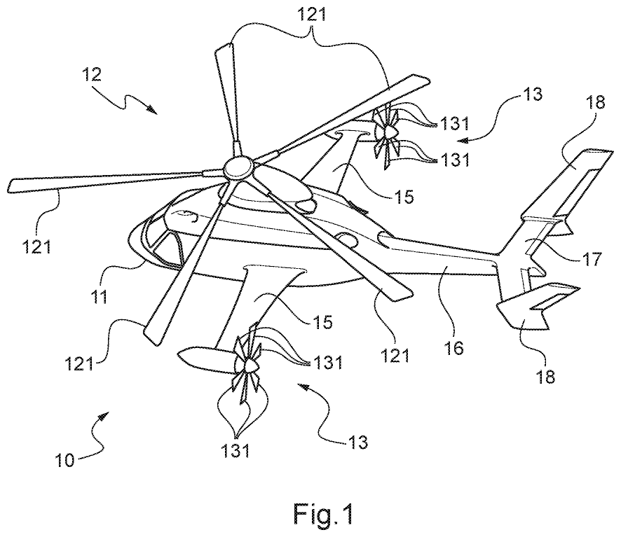

### DETAILED DESCRIPTION OF THE INVENTION

Elements present in more than one of the figures are given the same references in each of them.

Each figure shows a hybrid helicopter 10, 20 having a fuselage 11, a tail boom 16, a main rotor 12, two propulsion propellers 13, and two wings 15. The hybrid helicopter 10, 20 has a power plant driving rotation of the main rotor 12 and of the propulsion propellers 13.

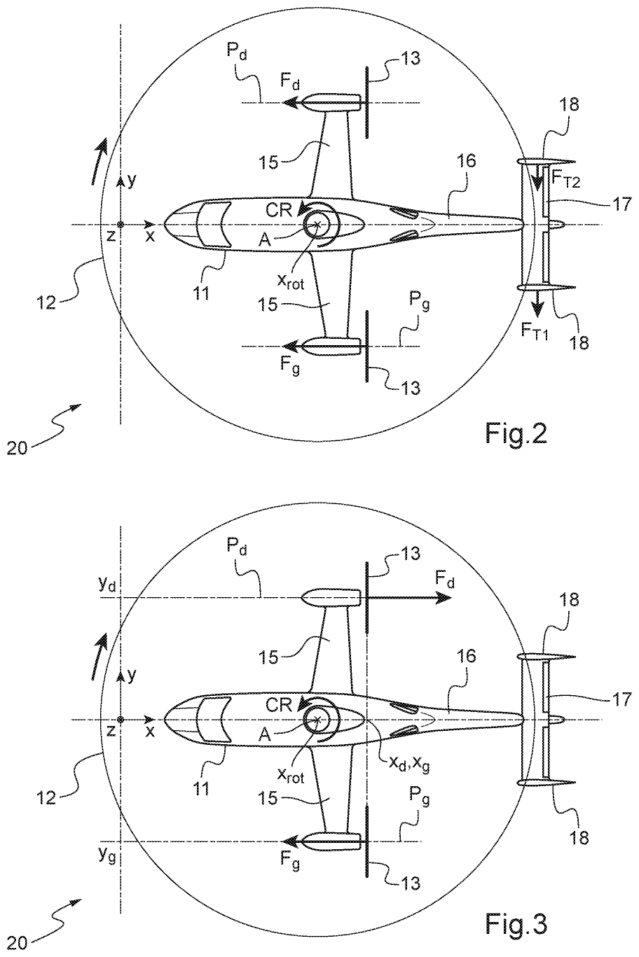

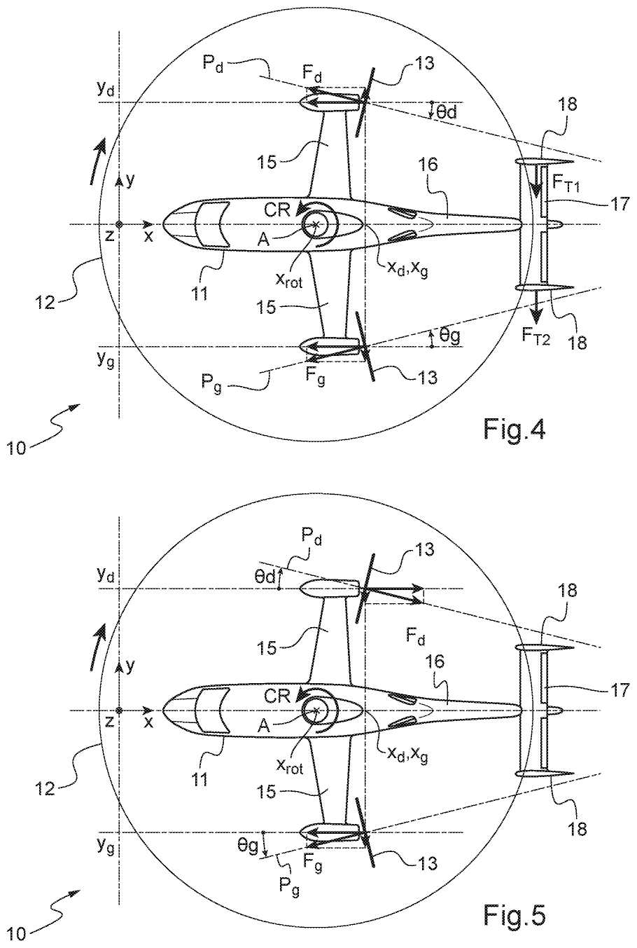

FIGS. 2 and 3 show a hybrid helicopter 20 of the prior art, whereas FIGS. 4 to 7 show two embodiments of a hybrid helicopter 10 of the invention.

In each figure, it should be observed that three directions X, Y, and Z are shown to form an (X, Y, Z) rectangular reference frame.

The first direction X is said to be longitudinal and extends from the front towards the rear of the hybrid helicopter 10, 20, i.e. from the front tip of the fuselage 11 of the hybrid helicopter 10, 20 to the rear end of its tail boom 16. The term “longitudinal” relates to any direction parallel to the longitudinal direction X.

The second direction Y is said to be transverse and it extends from the left to the right of the hybrid helicopter 10, 20. The term “transverse” relates to any direction that is parallel to the transverse direction Y.

Finally, the third direction Z is said to be in elevation and it extends upwards. The terms “elevation” and “vertical” relate to any direction parallel to the elevation direction Z.

The main rotor 12 of the hybrid helicopter 10, 20 has a plurality of main blades 121 and, while rotating about its center of rotation A, it serves to generate an aerodynamic force that provides the hybrid helicopter 10, with lift, and possibly also with propulsion. The center of rotation A of the main rotor 12 is close to the yaw axis of the hybrid helicopter 10, 20.

The two propulsion propellers 13 are situated transversely on either side of a front-to-rear plane XZ of the hybrid helicopter 10, 20 as formed by the longitudinal and elevation directions X and Z, and in particular they are situated on either side of the fuselage 11. Each propulsion propeller 13 has a plurality of secondary blades 131 and, while rotating, serves to generate a thrust force F_{d}, F_{g} directed along a thrust axis P_{d}, P_{g} of the propulsion propeller 13 for driving advance of the hybrid helicopter 10, 20.

The two wings 15 extend transversely on either side of the fuselage 11 so as to form a lift surface. A respective propulsion propeller 13 is positioned at each end of each wing 15.

At its rear end, the tail boom 16 has a substantially horizontal stabilizer 17 and two substantially vertical stabilizers 18. These stabilizers 17, 18 contribute in particular to stabilizing the hybrid helicopter 10, 20 aerodynamically in flight. The vertical stabilizers 18 also serve to generate a transverse aerodynamic force in cruising flight so as to oppose at least in part the yaw torque C_{R} of the hybrid helicopter 10, 20 and/or so as to generate movement of the hybrid helicopter 10, 20 about its yaw axis.

In FIGS. 2 to 7, the main rotor 12 turns clockwise about the center of rotation A. Under such circumstances, the yaw torque C_{R} is directed counterclockwise and is applied to the fuselage 11.

FIGS. 2 and 3 are two plan views of a prior art hybrid helicopter 20. The two propulsion propellers 13 are arranged on the wings 15 in such a manner that the thrust axes P_{d}, P_{g} of the two propulsion propellers 13 are parallel to the longitudinal direction X. FIG. 2 shows the prior art hybrid helicopter 20 during cruising flight, while FIG. 3 shows it during hovering flight.

For cruising flight, it can be seen that both propulsion propellers 13 supply identical thrust forces F_{d}, F_{g} directed towards the front of the prior art helicopter 20, along their respective thrust axes P_{d}, P_{g}. The vertical stabilizers 18 generate two transverse forces F_{T1}, F_{T2} opposing the yaw torque C_{R} of the hybrid helicopter 20. These two thrust forces F_{d}, F_{g} add together to form a traction force F_{tract} of the hybrid helicopter 20 that is used to cause the hybrid helicopter 20 to advance and to enable it to fly at a high speed of advance. This traction force F_{tract} as supplied jointly by the two propulsion propellers 13 for cruising flight is defined by the following equation:

F_{tract}=F_{d}+F_{g}

For hovering flight, the two propulsion propellers 13 supply opposite thrust forces F_{d}, F_{g} directed along their thrust axes P_{d}, P_{g} and directed for a first propulsion propeller 13 towards the rear of the hybrid helicopter 20 and for a second propulsion propeller 13 towards the front of the hybrid helicopter 20.

Since the main rotor 12 rotates clockwise when seen from above, the thrust force F_{d} of the right propulsion propeller 13 is directed towards the rear of the hybrid helicopter 20 and the thrust force F_{g} of the left propulsion propeller 13 is directed towards the front, as shown in FIG. 3. As a result, the thrust forces F_{d} and F_{g} are used for generating a moment Mₛₜₐₜ opposing the yaw torque C_{R} of the hybrid helicopter 20.

This moment Mₛₜₐₜ generated by the two propulsion propellers 13 for hovering flight is defined by the equation:

Mₛₜₐₜ=F_{d}(y_{d}, y_{Rot})+F_{g}(y_{g}-y_{Rot})

For both embodiments of a hybrid helicopter 10 of the present invention as shown in FIGS. 4 to 7, the two propulsion propellers 13 are arranged at the ends of respective wings 15 and they are inclined in such a manner that the thrust axes P_{d}, P_{g} of the two propulsion propellers 13 are inclined relative to the longitudinal direction X. Each thrust axis P_{d}, P_{g} thus forms an angle θ_{d}, θ_{g} with the longitudinal direction X in a horizontal plane parallel to the longitudinal and transverse directions X and Y.

In the first embodiment shown in FIGS. 4 and 5, the propulsion propellers 13 are arranged behind the center of rotation A of the main rotor 12, with the longitudinal coordinate x_{d}, x_{g} of each propulsion propeller 13 in the (X, Y, Z) reference frame being greater than the longitudinal coordinate x_{Rot} of the center of rotation A of the main rotor 12, and such that their thrust axes P_{d}, P_{g} converge on each other towards the rear of the hybrid helicopter 10. FIG. 4 is a plan view of the hybrid helicopter 10 of the invention during cruising flight, while FIG. 5 is a plan view of the hybrid helicopter 10 during hovering flight.

For cruising flight, both propulsion propellers 13 supply thrust forces F_{d}, F_{g} of the same magnitude and directed towards the front of the hybrid helicopter 10 along their respective thrust axes P_{d}, P_{g}. Since each thrust force F_{d}, F_{g} acts along its thrust axis P_{d}, P_{g} and is thus inclined relative to the longitudinal direction X, it can be resolved into a longitudinal component and a transverse component. Since the thrust forces F_{d}, F_{g} are of the same magnitude, their transverse components cancel, since these two transverse components are directed in two opposite directions. Under such circumstances, the longitudinal components of these two thrust forces F_{d}, F_{g} add so as to form a traction force F_{tract} for the hybrid helicopter 10 defined by the following equation:

F_{tract}=F_{d}cos(θ_{d})+F_{g}cos(θ_{g})

This fraction force F_{tract} supplied jointly by the two propulsion propellers 13 is then used to generate advance of the hybrid helicopter 10 and to enable it to fly at a high speed of advance.

Furthermore, during cruising flight, the vertical stabilizers 18 generate two transverse aerodynamic forces F_{T1}, F_{T2} that oppose the yaw torque C_{R} of the hybrid helicopter 10.

In hovering flight, the two propulsion propellers 13 supply thrust forces F_{d}, F_{g} directed along their respective thrust axes P_{d}, P_{g} and directed towards the rear of the hybrid helicopter 10 for a first propulsion propeller 13 and towards the front of the hybrid helicopter 10 for the second propulsion propeller 13. Since the main rotor 12 is rotating in the clockwise direction when seen from above, the thrust force F_{d} of the right propulsion propeller 13 is directed towards the rear of the hybrid helicopter 10 while the thrust force F_{g} of the left propulsion propeller 13 is directed towards the front, as shown in FIG. 5. Once more, each thrust force F_{d}, F_{g} can be resolved into a longitudinal component and a transverse component.

The longitudinal component of each thrust force F_{d}, F_{g} generates torque in the clockwise direction while applying a transverse lever arm equal to the difference between the transverse coordinate y_{d}, y_{g} of the thrust force F_{d}, F_{g} and the transverse component y_{Rot} of the center of rotation A of the main rotor 12 in the (X, Y, Z) reference frame. Furthermore, the transverse component of each thrust force F_{d}, F_{g} also generates a clockwise torque while applying a longitudinal lever arm equal to the difference between the longitudinal coordinate x_{d}, x_{g} of the thrust force F_{d}, F_{g} and the longitudinal component x_{Rot} of the center of rotation A of the main rotor 12. Under such circumstances, the longitudinal and transverse components of these two thrust forces F_{d}, F_{g} combine advantageously for generating a moment Mₛₜₐₜ about the center of rotation A that is equal to the sum of these torques and that serves to balance the yaw torque C_{R} of the hybrid helicopter 10. This moment Mₛₜₐₜ is defined during hovering flight of the hybrid helicopter 10 in this first embodiment by the following equation:

Mₛₜₐₜ=F_{d}((y_{d}-y_{Rot})cos(θ_{d})−(x_{d}-x_{Rot})sin(θ_{d})) +F_{g}((y_{g}-y_{Rot})cos(θ_{g})−(x_{g}-x_{Rot})sin(θ_{g}))

where the angle θ_{d}, θ_{g} is measured from the longitudinal direction X towards the thrust axis P_{d}, P_{g} as shown in FIGS. 4 and 5, and is considered to be positive in the counterclockwise (trigonometrical direction).

It can be seen that the moment Mₛₜₐₜ generated by the propulsion propellers 13 for the hybrid helicopter 10 in this first embodiment is advantageously greater than the moment Mₛₜₐₜ of a prior art hybrid helicopter 20 firstly because of the inclination of the thrust axis P_{d}, P_{g} of each propulsion propeller 13 and secondly because of the longitudinal lever arm applied to the thrust force F_{d}, F_{g} of each propulsion propeller 13, and more particularly to its transverse component. This increase in the moment Mₛₜₐₜ is accompanied by a small decrease in the traction force F_{tract} of the propulsion propellers 13.

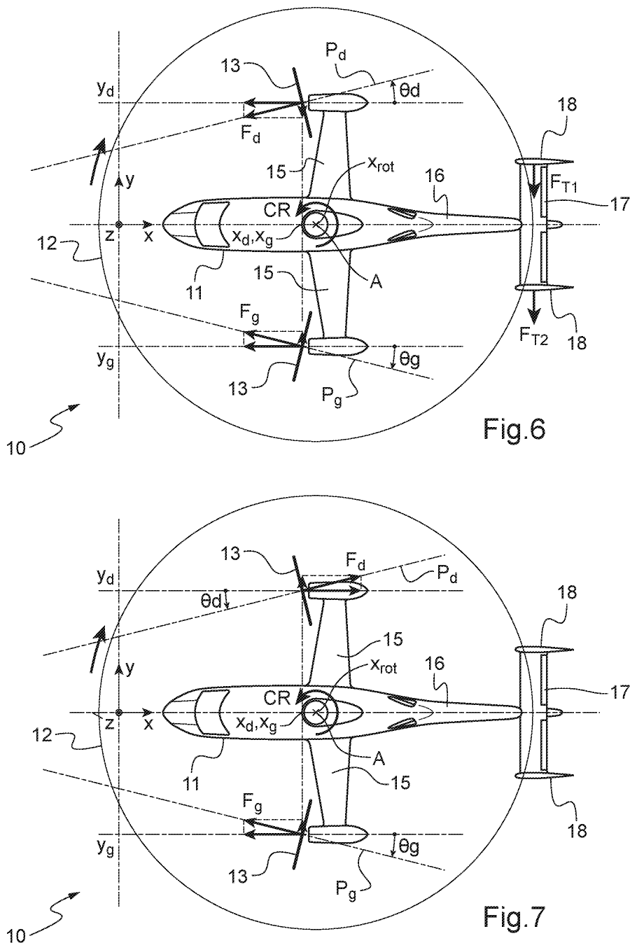

In the second embodiment shown in FIGS. 6 and 7, the propulsion propellers 13 are arranged in front of the center of rotation A of the main rotor 12, with the longitudinal coordinates x_{d}, x_{g} of each propulsion propeller 13 in the (X, Y, Z) reference frame being less than the longitudinal components x_{Rot} of the center of rotation A of the main rotor 12, such that their thrust axes P_{d}, P_{g} converge on each other towards the front of the hybrid helicopter 10. FIG. 6 is a plan view of the hybrid helicopter 10 during cruising flight, while FIG. 7 is a plan view of the hybrid helicopter 10 during hovering flight.

Such an inclination of the thrust axes P_{d}, P_{g} of the propulsion propellers 13 in this second embodiment, combined with each propulsion propeller 13 being positioned longitudinally in front of the center of rotation A of the main rotor 12 has the same effects on the traction force F_{tract} and on the moment Mₛₜₐₜ as the inclination of the thrust axes P_{d}, P_{g} of the propulsion propellers 13 in the first embodiment in combination with those propulsion propellers 13 being longitudinally positioned behind the center of rotation A of the main rotor 12, i.e. there is an increase in the moment Mₛₜₐₜ generated by the propulsion propellers 13 and a slight reduction in the traction force F_{tract} of the propulsion propellers 13.

The moment Mₛₜₐₜ is then defined during hovering flight of the hybrid helicopter 10 in this second embodiment by the same equation as for the first embodiment, the angles θ_{d}, θ_{g} still being measured from the longitudinal direction X towards the thrust axis P_{d}, P_{g} as shown in FIGS. 6 and 7, and being considered to being positive in the counterclockwise direction.

Naturally, the present invention may be subjected to numerous variations as to its implementation. Although several embodiments are described, it will readily be understood that it is not conceivable to identify exhaustively all possible embodiments. It is naturally possible to envisage replacing any of the means described by equivalent means without going beyond the ambit of the present invention.

1. A hybrid helicopter having a longitudinal direction (X) extending from the front of the hybrid helicopter towards the rear of the hybrid helicopter, an elevation direction (Z) extending upwards perpendicularly to the longitudinal direction (X), and a transverse direction (Y) extending from the left towards the right of the hybrid helicopter, perpendicularly to the longitudinal and elevation directions (X, Z), the hybrid helicopter comprising:
a fuselage;
a main rotor rotatable about a center of rotation (A);
two wings situated on either side of the fuselage relative to a front-to-rear plane (XZ) formed by the longitudinal direction (X) and the elevation direction (Z);
at least two propulsion propellers situated transversely on either side of the front-to-rear plane (XZ) of the hybrid helicopter at least one propulsion propeller being arranged on either each wing, each propulsion propeller having a thrust axis (P_{d}, P_{g}) along which a thrust force (F_{d}, F_{g}) is generated while the propulsion propeller is rotating; and
a power plant driving the main rotor and each propulsion propeller in rotation;
wherein the thrust axis (P_{d}, P_{g}) of each propulsion propeller is inclined relative to the longitudinal direction (X), with the thrust force (F_{d}, F_{g}) generated by each propulsion propeller while rotating comprising a longitudinal component and a transverse component, and each propulsion propeller is offset longitudinally relative to the center of rotation (A) of the main rotor in such a manner that the longitudinal component and the transverse component of the thrust force (F_{d}, F_{g}) of each propulsion propeller act during hovering flight of the hybrid helicopter to generate a respective moment (Mₛₜₐₜ) balancing a yaw torque (C_{R}) of the hybrid helicopter.

2. The hybrid helicopter according to claim 1, wherein the hybrid helicopter has two propulsion propellers, respectively a right propeller and a left propeller situated transversely on either side of the front-to-rear plane (XZ), the moment (Mₛₜₐₜ) generated by the thrust forces (F_{d}, F_{g}) of the two propulsion propellers being determined by the following equation:
Mₛₜₐₜ=F_{d}((y_{d}-y_{Rot})cos(θ_{d})−(x_{d}-x_{Rot})sin(θ_{d})) +F_{g}((y_{g}-y_{Rot})cos(θ_{g})−(x_{Rot})sin(θ_{g}))
F_{d}, F_{g} being the magnitude of the thrust force (F_{d}, F_{g}) generated by the rotation of the right or left propulsion propeller respectively;
x_{d}, x_{g} being a longitudinal coordinate along the longitudinal direction (X) of the right and left propulsion propellers respectively;
y_{d}, y_{g} being a transverse coordinate along the transverse direction (Y) of the right and left propulsion propellers respectively;
x_{Rot} being a longitudinal coordinate along the longitudinal direction (X) of the center of rotation (A) of the main rotor;
y_{Rot} being the transverse coordinate along the transverse direction (Y) of the center of rotation (A) of the main rotor; and
θ_{d}, B_{g} being an angle measured from the longitudinal direction (X) towards the thrust axis (P_{d}, P_{g}) of the right or left propulsion propeller respectively, with the counterclockwise direction being considered as positive.

3. The hybrid helicopter according to claim 1, wherein for the propulsion propellers, the angles (P_{d}, P_{g}) between the longitudinal direction (X) and the thrust axis (P_{d}, P_{g}) of each propulsion propeller are identical.

4. The hybrid helicopter according to claim 1, wherein the propulsion propellers are arranged behind the main rotor along the longitudinal direction (X), and the thrust axes (P_{d}, P_{g}) of the propulsion propellers converge towards the rear of the hybrid helicopter.

5. The hybrid helicopter according to claim 1, wherein the propulsion propellers are arranged in front of the main rotor along the longitudinal direction (X), and the thrust axes (P_{d}, P_{g}) of the propulsion propellers converge towards the front of the hybrid helicopter.

6. The hybrid helicopter according to claim 1, wherein the angle (θ_{d}, θ_{g}) between the longitudinal direction (X) and the thrust axis (P_{d}, P_{g}) of the propulsion propeller lies in the range 0° and a maximum angle θₘₐₓ defined as a function of the position of the propulsion propeller relative to the center of rotation (A) of the main rotor, such that:
$${θ}_{max} = atan ( \frac{x - {x}_{Rot}}{y - {y}_{Rot}} )$$
